(19) United States
(12) Patent Application Publication
(10) Pub. No.: US 2025/0271890 A1
(43) Pub. Date: Aug. 28, 2025

(54) COMPLEMENTARY TO ABSOLUTE TEMPERATURE (CTAT) CIRCUIT

(71) Applicants: Infineon Technologies AG, Neubiberg (DE); Universita degli Studi di Milano-Bicocca, Milano (IT)

(72) Inventors: Osvaldo Gasparri, Lecco (IT); Paolo Del Croce, Villach (AT); Lorenzo Pulcini, Savona (IT); Andrea Baschirotto, Tortona (IT)

(21) Appl. No.: 19/059,716

(22) Filed: Feb. 21, 2025

(30) Foreign Application Priority Data
Feb. 22, 2024 (DE) 102024105065.9

(51) Int. Cl. G05F 3/26; G01K 7/01

(52) U.S. Cl. CPC G05F 3/267; G01K 7/01

(57) ABSTRACT

In accordance with an embodiment, a circuit includes: a switched-capacitor voltage divider; a voltage-to-current converter coupled to an output of the switched-capacitor voltage divider, wherein a first output node of the voltage-to-current converter is configured to provide a CTAT current with respect to a reference resistance; a current mirror having an input coupled to a second output node of the voltage-to-current converter, and a diode junction coupled to an output of the current mirror and to an input of the switched-capacitor voltage divider.

This application claims the benefit of German Patent Application No. 102024105065.9, filed on Feb. 22, 2024, which application is hereby incorporated herein by reference.

### TECHNICAL FIELD

This application relates to the field of bandgap voltage reference circuits and, in particular, to a circuit for generating a current that is complementary to absolute temperature (CTAT).

### BACKGROUND

Bandgap voltage reference circuits are circuits that are widely used in voltage regulators and other integrated circuits. They generate an essentially temperature-independent voltage that corresponds to the theoretical bandgap of a semiconductor. With this, it is possible to increase the performance of a circuit in a given temperature range.

Bandgap reference circuits are based on the current sum of a current I_{PTAT} that is Proportional To Absolute Temperature (PTAT current) and of a current I_{CTAT} that is Complementary To Absolute Temperature (CTAT current). Such PTAT and CTAT currents are generated by applying PTAT and CTAT voltages to reference resistors. Summing the two currents makes it possible to cancel out the temperature-dependent terms of the currents and, thus, to obtain a voltage that is essentially independent of the temperature in the desired temperature range.

For low-power bandgap operations, such as idle (parking) mode operations of a vehicle, very low CTAT currents are desired. However, this requires the reference resistor to have a large resistance and, thus, to occupy a large area.

### SUMMARY

Some embodiments include a switched capacitor voltage divider that is arranged between a diode and the resistor of a CTAT circuit.

In one example, the disclosure is directed to a circuit comprising a resistor and a diode. The diode is configured to receive a diode current so that a forward voltage occurs across the diode. The circuit further comprises a switched capacitor voltage divider and a voltage-to-current converter. The switched capacitor voltage divider is connected to the diode and configured to receive the forward voltage and to output a scaled voltage that is a fraction of the forward voltage. The voltage-to-current converter is coupled between the switched capacitor voltage divider and the resistor and that is configured to provide a resistor current, which is proportional to the scaled voltage and inversely proportional to a resistance of the resistor. The circuit also comprises a current source configured to provide the diode current dependent on the resistor current.

In one example, the disclosure is directed to a method comprising the steps of: supplying a diode current to a diode so that a forward voltage occurs across the diode; generating, by a switched capacitor voltage divider, a scaled voltage from the forward voltage; and providing a resistor current, which is proportional to the scaled voltage and inversely proportional to a resistance of a resistor, wherein the diode current depends on the resistor current.

### BRIEF DESCRIPTION OF THE DRAWINGS

The embodiments described herein can be better understood with reference to the following description and drawings. The components in the figures are not necessarily to scale, emphasis instead being placed upon illustrating the principles of the embodiments. Furthermore, in the figures, like reference numerals designate corresponding parts. In the drawings:

FIG. 1 illustrates one example of a bandgap reference circuit;

FIG. 2 illustrates one conventional example of a circuit for generating a current that is complementary to absolute temperature (CTAT circuit);

FIG. 3 illustrates one example of a circuit structure for a CTAT circuit in accordance with one or more techniques described herein;

FIG. 4 illustrates another example of circuit structure for a CTAT circuit in accordance with one or more techniques described herein;

FIG. 5 illustrates a first example of a CTAT circuit in more detail;

FIG. 6 illustrates a second example of a CTAT circuit;

FIG. 7 illustrates a third example of a CTAT circuit;

FIG. 8 illustrates a fourth example of a CTAT circuit which is a modified version of the example of FIG. 7;

FIG. 9 illustrates one example of a bandgap reference generator in accordance with one or more techniques described herein, which uses the CTAT circuit of any one of FIGS. 5 to 8; and

FIG. 10 is a flowchart illustrating an example method for operating a CTAT circuit, in accordance with one or more techniques described in this disclosure.

### DETAILED DESCRIPTION OF ILLUSTRATIVE EMBODIMENTS

Some embodiments provide a circuit for generating a CTAT current for a low-power bandgap reference that advantageously reduces current level and/or resistor area.

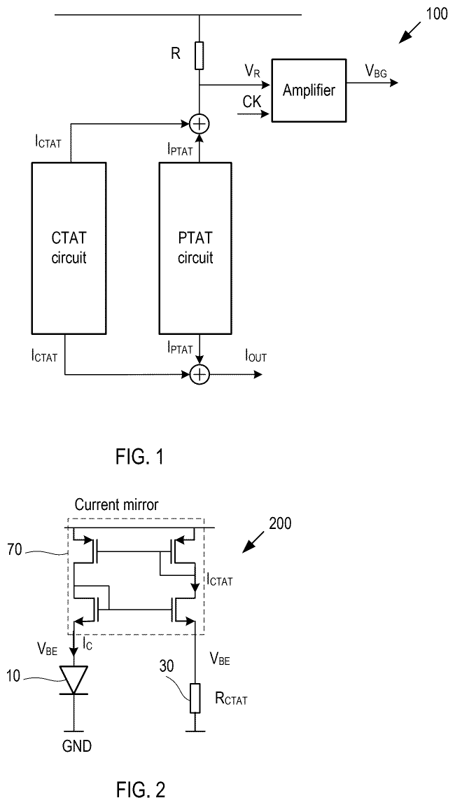

FIG. 1 shows a general example of a bandgap reference voltage circuit 100 configured to generate a reference voltage V_{BG} that is essentially temperature-independent in a desired temperature range. The circuit comprises a first circuit that is configured to generate a current I_{PTAT} that is proportional to absolute temperature (PTAT circuit) and a second circuit that is configured to generate a current I_{CTAT} that is complementary to absolute temperature (CTAT circuit). In order to obtain the currents I_{PTAT} and I_{CTAT}, PTAT and CTAT voltages are applied to corresponding reference resistors.

The circuit further comprises a first summing element that is configured to sum the PTAT current I_{PTAT} and the CTAT current I_{CTAT} to obtain a reference current that is applied to a resistor R. The voltage drop VR across the resistor R is received as an input by an amplifier that is controlled by a clock signal CK. The amplifier provides the desired bandgap voltage V_{BG} as an output. The circuit further may comprise a second summing element that sums the currents I_{PTAT} and I_{CTAT} and provides a current output.

FIG. 2 shows an example of a conventional CTAT circuit 200 for generating a CTAT current I_{CTAT}. The circuit comprises a resistor 30 having a resistance R_{CTAT} and a diode 10 through which a current I_{C} flows so that a forward voltage V_{BE} occurs across the diode 10. The forward voltage V_{BE} is referred to as CTAT voltage. The diode 10 may be the base-emitter diode of a bipolar transistor and the forward voltage V_{BE} may thus correspond to the base-emitter voltage of the bipolar transistor. The circuit also comprises a current source that couples the diode 10 and the resistor 30. In the present example, the current source comprises a current mirror 70 that is configured to supply the resistor 30 with a resistor current I_{CTAT} and also to provide the current I_{C} that flows through the diode 10 dependent on the resistor current I_{CTAT}. A voltage drop across the resistor R_{CTAT} is substantially equal to the forward voltage V_{BE}. The resistor current I_{CTAT} is thus proportional to the forward voltage V_{BE} and inversely proportional to the resistance R_{CTAT}: I_{CTAT}=V_{BE}/R_{CTAT}. The transistors may be configured in such a way that the current I_{C} is equal to the current I_{CTAT}.

Because it is based on a PN junction and uses an actual resistor, the depicted CTAT circuit is particularly robust. Further, it is very easy to implement and does not require any precise clock.

However, the main drawback of this circuit is its current consumption. The CTAT voltage, which is typically the base-emitter voltage V_{BE} of a bipolar transistor, conventionally ranges from 400 mV to 700 mV over PVT (Process, Voltage, Temperature). This leads to resistor currents I_{CTAT} that may be up to 700 mV/R_{CTAT}.

For low-power bandgap operations, as needed, for example, during idle mode (parking) of a vehicle, the CTAT current has to be very low. However, in order to obtain CTAT currents that are lower than 1 μA, the resistance of the resistor 30 has to be relatively high, e.g. higher than 1 MOhm. This means that the resistor 30 occupies a large chip area. According to one example, in order to obtain a CTAT current of 500 nA, the resistance of the resistor R_{CTAT} has to be equal to 1.2 MOhm.

The conventional CTAT circuit is thus based on a trade-off between the R_{CTAT} value, which should be as low as possible, and the CTAT current, which also has to be as low as possible.

Accordingly, the embodiments described herein aim at solving this trade-off problem, namely to provide a circuit that is able to reduce the CTAT current and the chip area at the same time. In particular, there is a need for a circuit that is robust in the desired operation conditions, namely a supply voltage from 3.3V down to 2V and a temperature range between-40° C. and 175° C.

There are known solutions, in which a MOS transistor operating in Weak Inversion mode is used to provide the CTAT voltage or in which a MOS transistor operating in linear region is used as the resistor. However these solutions are not reliable in the above-mentioned operation conditions.

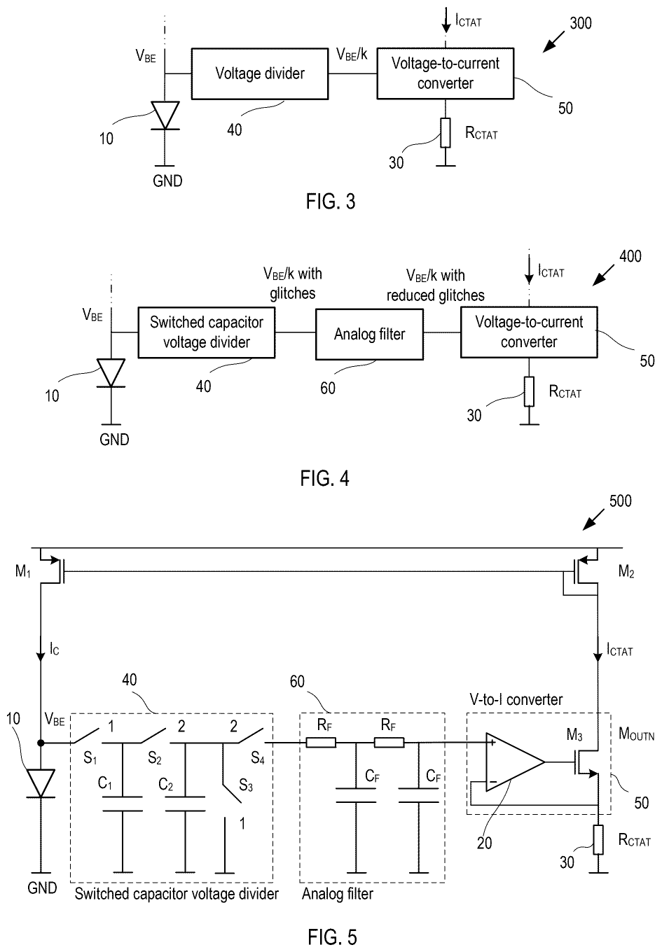

FIG. 3 illustrates an example of a circuit 300 that can be used in a CTAT circuit. The circuit comprises a diode 10 and a resistor 30 that has a resistance R_{CTAT}. A voltage divider 40 is arranged between the diode 10 and the resistor 30. The voltage divider 40 is configured to reduce the CTAT voltage V_{BE} across the diode 10 by a factor k down to V_{BE}/k. Specifically, the voltage divider 40 is connected to the diode 10 and is configured to receive the forward voltage V_{BE} and to output a scaled voltage V_{BE}/k that is a fraction of the forward voltage V_{BE}. The circuit 300 further comprises a voltage-to-current converter 50 that is coupled between the voltage divider 40 and the resistor 30. The voltage-to-current converter 50 is configured to provide a resistor current I_{CTAT} to the resistor 30 such that the voltage across the resistor 30 equals the scaled voltage V_{BE}/k. The resistor current I_{CTAT} is proportional to the scaled voltage V_{BE}/k and inversely proportional to the resistance R_{CTAT} of the resistor 30. This circuit thus makes it possible to reduce the current I_{CTAT} by a factor k with respect the solution without voltage divider. As a consequence, it is also possible to reduce the resistance R_{CTAT} of the resistor 30, since this reduction can be (at least partly) compensated by the scaling of the voltage V_{BE}. Reducing the resistance R_{CTAT} leads to a decrease in the required chip space for the resistor 30 and, thus, to a more compact assembly as well as to a reduced power consumption.

According to one embodiment, the voltage divider 40 is a switched capacitor voltage divider. A switched capacitor voltage divider is a simple solution for producing a scaled voltage. However, the switching operations in the capacitive divider may result in glitches due to charge injection and clock feedthrough.

FIG. 4 illustrates a further example of a circuit 400 that can be used in a CTAT circuit. This circuit can be considered an improvement/exemplary implementation of the circuit 300 of FIG. 3. It comprises a switched capacitor voltage divider 40 as the voltage divider. The circuit 400 further comprises an analog filter 60 that is connected between the switched capacitor voltage divider 40 and the voltage-to-current converter 50. The analog filter 60 is configured to smooth the artifacts produced by the voltage divider operation to produce the scaled voltage V_{BE}/k with reduced glitches. This smoothed scaled voltage is then fed to the voltage-to-current converter 50.

FIG. 5 illustrates a more detailed example of a CTAT circuit 500 for generating a CTAT current I_{CTAT}. It is one possible implementation of the example of FIG. 4. In addition to the elements already described with regard to FIG. 4, it further comprises a current source. The different elements of the circuit will be described in further details below.

In the depicted example, the voltage divider 40 is realized with a passive charge sharing capacitive array of two capacitors. The switched capacitor voltage divider 40 comprises a first capacitor C₁ with a first end that can be connected to the diode 10 via a first switch S₁ and a second end that is connected to ground. The voltage divider 40 further comprises a second capacitor C₂ with a first end that can be coupled in parallel with the first capacitor C₁ via a second switch S₂ and a second end that is connected to ground. The second capacitor C₂ can either be connected to the ground (to be discharged) via a third switch S₃ or to an output of the voltage divider 40 via a fourth switch S₄. The first capacitor C₁ has a first capacitance C and the second capacitor C₂ has a second capacitance (k−1)·C which is a factor (k−1) larger than the first capacitance C, k being the division ratio of the switched capacitor voltage divider 40. The voltage divider 40 also comprises a controller with a clock phase generator, which is not shown in FIG. 5 to keep the illustration simple. The controller is configured to control the switching operations of the switched capacitor voltage divider 40 in a conventional way.

The switched capacitor voltage divider 40 operates as follows:

During a first time period (Phase 1 as shown in FIG. 5), the first capacitor C₁ is connected to the diode 10 via the first switch S and disconnected from the second capacitor C₂ using the second switch S₂, so that the forward voltage V_{BE} is applied to the first capacitor C₁. The first capacitor C₁ is thus charged with a charge Q_{VBE}=C·V_{BE}. In the same phase, the third switch S₃ is switched on and the fourth switch S₄ is switched off, so that the second capacitor C₂ is connected to ground with both ends. The second capacitor C₂ is thus fully discharged. The reference number “1” in the figure indicates which switches are switched on during the first phase.

During a second time period (Phase 2 as shown in FIG. 5), the first capacitor C₁ is disconnected from the diode 10 using the first switch S₁ and is connected to the second capacitor C₂ via the second switch S₂. The two capacitors are thus connected in parallel and the charge Q_{VBE} is shared among them. The voltage across the capacitors is thus V_{X}=Q_{VBE}/(C+C (k−1))=Q_{VBE}/(k·C)=V_{BE}/k. Meanwhile, the third switch S₃ is switched off and the fourth switch S₄ is switched on. The voltage divider thus outputs a scaled voltage that is equal to V_{BE}/k. The reference number “2” in the figure indicates which switches are switched on during the second phase.

This operation uses only passive components and does not require any power consumption. The charge-sharing concept has the advantage to be insensible to clock phase inaccuracy. The accuracy of the operation may, however, be limited by the capacitor matching and by charge injection. The charge injection can be minimized by minimizing the size of the switch devices.

It is clear that the number of capacitors of the switched capacitor voltage divider 40 is not restricted to two and the skilled person would know how to implement further capacitors in the above concept. However, increasing the number of capacitors also increases the control complexity of the voltage divider.

In the depicted example, the analog filter 60 is a two-stage passive RC low-pass filter, each stage comprising a resistor R_{F} and a capacitor C_{F}, wherein the two RC filter stages are coupled in series. According to one example, the resistors R_{F} may be implemented using high-resistance NMOS transistors operating in linear region. The analog filter 60 is configured to reduce the glitches of the scaled voltage V_{BE}/k output by the switched capacitor voltage divider 40 and to output a smoothed scaled voltage to the voltage-to-current converter 50.

In the depicted example, the voltage-to-current converter 50 comprises an operational amplifier 20 and a transistor M₃. The input of the converter 50 is connected to the output of the analog filter 60 and thus receives the smoothed scaled voltage V_{BE}/k. An output of the converter 50 is connected to a first end of the resistor 30. The operational amplifier 20 and the third transistor M₃ are coupled such that the transistor M₃ provides, as resistor current, a current I_{CTAT} that is proportional to an input voltage V_{BE} of the voltage-to-current converter and wherein the current I_{CTAT} has a level such that the voltage drop I_{CTAT}. R_{CTAT} across the resistor 30 equals V_{BE}/k. In the depicted example, the resistor current I_{CTAT} is the same current as the one that flows through the resistor 30 and is thus equal to: I_{CTAT}=V_{BE}/(k·R_{CTAT}). The bandwidth of the operational amplifier 20 may be designed to be very small in order to further reduce any residual switching artifacts in the smoothed scaled voltage V_{BE}/k.

In the depicted example, the transistor M₃ is a NMOS transistor. A first input of the operational amplifier 20 receives the smoothed scaled voltage V_{BE}/k and a second input of the operational amplifier 20 is connected to the source of the transistor M₃, which is also connected to the resistor 30. The drain of the transistor M₃ is connected to the current mirror, and the source of the transistor M₃ is connected to the first end of the resistor 30. An output of the operational amplifier 20 is connected to the gate of the transistor M₃.

The circuit 500 also comprises the current mirror that is configured to provide the diode current I_{C} dependent on the resistor current I_{CTAT}. In the depicted example, the current source comprises a current mirror with a first transistor M₁ coupled to the diode 10 and a second transistor M₂ coupled to the resistor R_{CTAT}. The first transistor M₁ (current mirror output branch) and the second transistor M₂ (current mirror input branch) are configured to provide, as diode current I_{C}, a replica of the resistor current I_{CTAT}. According to one example, the transistors M₁ and M₂ are PMOS transistors. In the depicted example, the source electrodes of both transistors M₁ and M₂ are connected to each other and to a supply. Further, the gate electrodes of both transistors M₁ and M₂ are connected to each other. A drain electrode of the first transistor M₁ is coupled to the diode 10 and a drain electrode of the second transistor M₂ is coupled to the resistor 30 and to the transistor M₃ of the voltage-to-current converter. According to another example, the transistors M₁ and M₂ are identical and the diode current I_{C} is equal to the resistor current I_{CTAT}.

With this circuit, it is possible to reduce both the resistor current I_{CTAT} and the resistance R_{CTAT} of the resistor 30. This reduction happens at the cost of the introduction of two active blocks.

The first active block is the clock phase generator for the switched capacitor voltage divider 40 (not shown). If the full bandgap circuit already comprises a clock phase generator, it can be used for the CTAT circuit. Otherwise, it will have to be added. However, since the concept of the switched capacitor voltage divider 40 is based on charge sharing and since the circuit is using very low-frequency voltages (or even DC voltages), the clock generator does not need to be precise in terms of frequency accuracy or phase jitter. This means that it is possible to use a very low-power oscillator, such as a current-limited ring oscillator. This oscillator can then also be used for other blocks of the full bandgap voltage reference circuit.

The second active block is the operational amplifier 20 of the voltage-to-current converter 50. As mentioned above, the bandwidth of the operational amplifier 20 can be designed to reduce the artefacts in the input scaled voltage V_{BE}/k. It is thus possible to use a very small-bandwidth operational amplifier with a very low power consumption.

In the example of FIG. 5, only passive elements are used in the switched capacitor voltage divider 40, and the clock for the switching operations is not required to be precise. Further, glitches that may be introduced by the switching operations of the switched capacitor voltage divider 40 can be smoothed by the analog filter 60 and by the use of an operational amplifier 20 in the voltage-to-current converter 50 that has a small bandwidth.

With the circuit of FIG. 5, because the downscaled forward voltage V_{BE}/k is applied to the resistor 30, it is possible to reduce both, the CTAT current I_{CTAT} and the resistance value R_{CTAT} of the resistor 30 compared to the solution without voltage divider. For example, if the scaling factor k is equal to 4, it is possible to reduce the CTAT current I_{CTAT} by two and to reduce the resistance R_{CTAT} by two as compared with the circuit of FIG. 2. According to one example, the resistance R_{CTAT} can be taken to be 600 kOhm, which is half of the value of the resistance in the example of FIG. 2. The current I_{CTAT} will then be equal to 250 nA, which is also half of the value of current in the example of FIG. 2.

In the example of FIG. 5, the current mirror (composed of M₁ and M₂ in the depicted example) is connected to a voltage source (supply voltage VDD) or a current source (supply current I_{BIAS}), while the diode 10 and the resistor 30 are connected to the ground. However, it is clear that this situation can be reversed without having to modify the rest of the circuit or losing any advantages of the circuit.

The CTAT circuit of FIG. 5 can be embedded in a full bandgap voltage reference circuit as illustrated in FIG. 1. Such a full bandgap voltage reference circuit uses the CTAT current I_{CTAT} of the CTAT circuit for different bandgap operations. It is thus important to be able to source or sink an output current from or by the CTAT circuit.

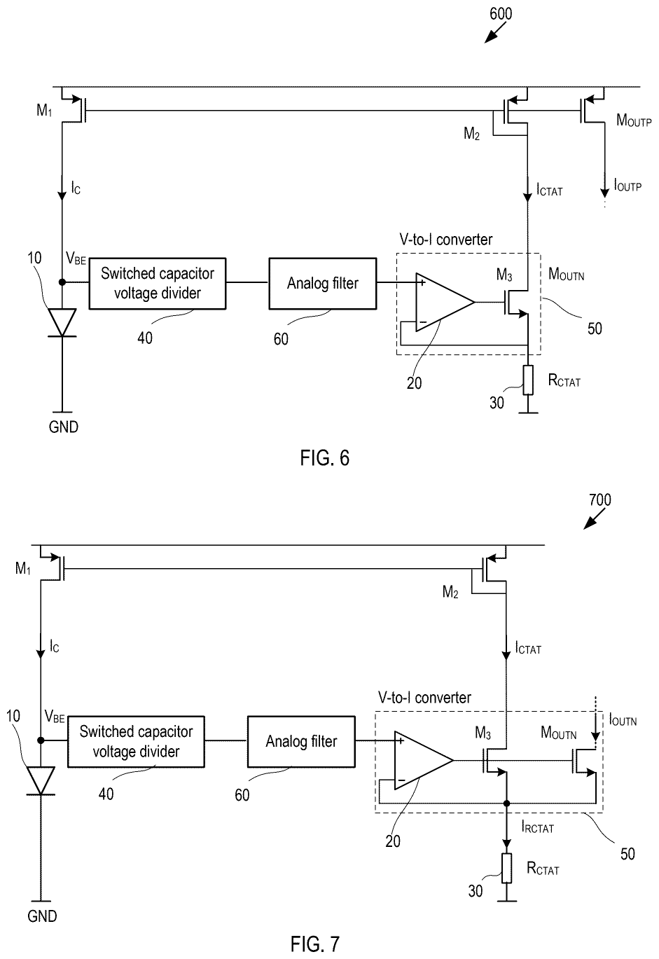

FIG. 6 illustrates a further example of a CTAT current circuit 600 that is able to source an output current I_{OUTP}. Compared with the circuit of FIG. 5, the circuit 600 comprises a further transistor M_{OUTP} that is arranged in a current mirror configuration with the second transistor M₂ of the current mirror. The control electrodes of the transistors M₂ and M_{OUTP} are connected to each other and the source electrodes of the transistors M₂ and M_{OUTP} are connected to each other. In the depicted example, the further transistor M_{OUTP} is a PMOS transistor. The further transistor M_{OUTP} is configured to mirror the current I_{CTAT} flowing through the transistor M₂, so that the output current I_{OUTP}, which flows through the further transistor M_{OUTP}, is proportional to the current I_{CTAT}. The output current I_{OUTP} can then be used for further bandgap operations. This solution does not change the operation of the CTAT circuit that provides the current I_{CTAT} and offers a reliable output current. That is, apart from the additional transistor M_{OUTP} the circuit of FIG. 6 is the same as the example of FIG. 5.

FIG. 7 illustrates another example of a CTAT current circuit 700 that is able to sink an output current I_{OUTN}. Compared with the circuit of FIG. 5, the voltage-to-current converter 50 further comprises an output transistor M_{OUTN} that is connected in a current mirror configuration to the other transistor M₃ of the voltage-to-current converter 50. In the depicted example, both the transistor M₃ and the output transistor M_{OUTN} are NMOS transistors. Specifically, a gate electrode of the output transistor M_{OUTN} is connected to a gate electrode of the transistor M₃ of the voltage-to-current converter and a source electrode of the output transistor M_{OUTN} is connected to the source electrode of the transistor M₃. With this, the transistors M₃ and M_{OUTN} are controlled in the same manner and have the same gate-source voltage. The output current I_{OUTN} is thus proportional to the resistor current I_{CTAT}. Both the current I_{CTAT}, which flows through the transistor M₃, and the current I_{OUTN}, which flows through the output transistor M_{OUTN}, also pass through the resistor 30, so that the total current I_{RCTAT} that flows through the resistor 30 is equal to: I_{RCTAT}=I_{CTAT}+I_{OUTN}. Since the voltage drop V_{BE}/k across the resistor 30 is not modified by the addition of the output transistor M_{OUTN}, the resistance R_{CTAT} of the resistor 30 is equal to: R_{CTAT}=(V_{BE}/k)/(I_{CTAT}+I_{OUTN}). By adding the output transistor M_{OUTN}, it is thus possible to use a resistor having a reduced resistance value R_{CTAT}, and thus to reduce the chip area required for the resistor 30. The output current I_{OUTN} can then be used for further bandgap applications. Apart from the additional transistor M_{OUTN}, the circuit of FIG. 7 is the same as the example of FIG. 5. Like in the example of FIG. 5, the resistor current I_{RCTAT}=I_{CTAT}+I_{OUTN} is proportional to the scaled voltage V_{BE}/k and inversely proportional to the resistance R_{CTAT} of the resistor 30. The transistor currents I_{CTAT} and I_{OUTN} are also proportional to each other.

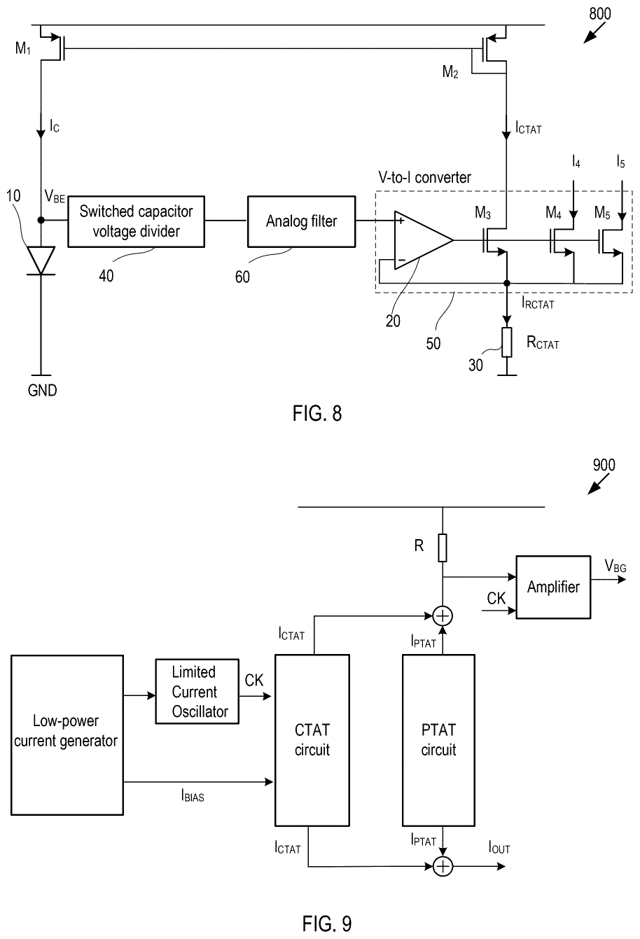

FIG. 8 illustrates a further example of a CTAT current circuit 800, which is a modification/enhancement of the circuit of FIG. 7. Compared with the circuit of FIG. 7, the circuit 800 does not comprise only one output transistor, but two output transistors M₄ and M₅. The first output transistor M₄ corresponds to the output transistor M_{OUTN} of FIG. 7 and a first output current I₄ flows through it. The second output transistor M₅ is connected to the first output transistor M₄ in a mirror configuration. Each output current I₄, I₅ is proportional to the resistor current I_{CTAT} and can be used for different bandgap operations. Both the first output current I₄ and the second output current I₅ flow through the resistor 30. The total current I_{RCTAT} flowing through the resistor 30 is thus: I_{RCTAT}=I_{CTAT}+I₄+I₅. It is thus possible to further reduce the resistance value R_{CTAT} of the resistor 30. According to one example, the scaling factor k is equal to 4 and the transistors M₄ and M₅ are chosen such that the resistance value R_{CTAT} is equal to 240 kOhm and the current I_{RCTAT} that flows through the resistor 30 is equal to 250 nA. Compared to the example of FIG. 2, the current value can be decreased by 50% and the resistance value can be decreased to 20% of the original value. The addition of the output transistors M₄ and M₅ can lead to a lower resistance value R_{CTAT}, which requires less chip area, and, thus, to a more compact structure. Like in the previous example, the resistor current I_{RCTAT}=I_{CTAT}+I₄+I₅ is proportional to the scaled voltage V_{BE}/k and inversely proportional to the resistance R_{CTAT} of the resistor 30. The transistor currents I_{CTAT}, I₄, and I₅ are also proportional to each other.

It is clear that the number of additional output transistors is not limited to two and that the skilled person may determine an optimal number of output transistors that can be added to the circuit of FIG. 5, the output transistors being connected in the same way as in FIGS. 7 and 8.

FIG. 9 shows an example of a full bandgap reference voltage circuit 900 in which the CTAT circuits of FIGS. 5 to 8 can be used. Compared to the circuit of FIG. 1, the bandgap reference voltage circuit 900 further comprises the above-mentioned limited-current oscillator that provides the clock signal for the switched capacitor voltage divider. Because such a voltage divider is based on the concept of charge sharing, the clock phase generator does not need to be particularly precise so that it is possible to use a limited current oscillator. In addition, the circuit comprises a low-power current generator that is configured to generate a reference current I_{BIAS} for the oscillator and for the CTAT circuit. With this, the full bandgap reference voltage circuit 900 can have a very low power consumption.

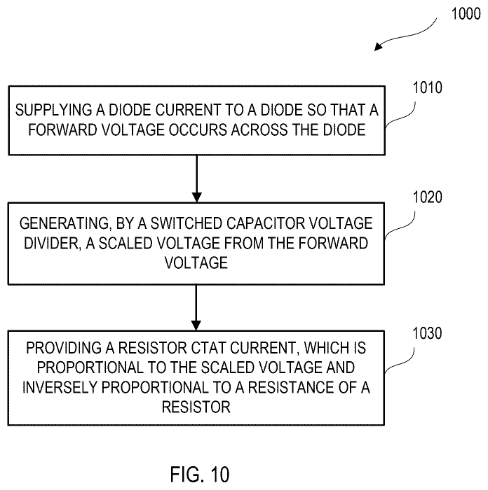

FIG. 10 is a flowchart illustrating an example method 1000 for operating a circuit for generating a CTAT current. The example process 1000 can be employed to operate devices illustrated in this disclosure, such as the circuits according to FIGS. 5 to 8.

Process 1000 includes supplying a diode current I_{C} to a diode 10 so that a forward voltage V_{BE} occurs across the diode (step 1010). The current I_{C} may be supplied by a current source. In one example, the current I_{C} is supplied by a current mirror that comprises two transistors arranged in a mirror configuration. In another example, the diode 10 is the diode of a bipolar transistor and the forward voltage V_{BE} is the base-emitter voltage of the bipolar transistor.

The process 1000 further comprises generating, by a switched capacitor voltage divider 40, a scaled voltage V_{BE}/k from the forward voltage V_{BE}, k being the scaling factor of the voltage divider 40 (step 1020). In one example, the switched capacitor voltage divider 40 is connected to the diode 10 and receives the forward voltage V_{BE}. The switched capacitor voltage divider 40 is connected to a controller with a clock phase generator, which controls the operation of the voltage divider 40. During a first time, a first capacitor C₁ of the switched capacitor voltage divider 40 is connected to the diode 10 via a first switch S₁ so as to apply the forward voltage V_{BE} to the first capacitor C₁. In the same time, a second capacitor C₂ of the switched capacitor voltage divider is disconnected from the first capacitor C₂ using a second switch S₂, and is connected to ground through a third switch S₃. During the first time, the first capacitor C₁ is thus charged with a charge C·V_{BE}, C being the capacitance of the first capacitor C₁, and the second capacitor C₂ is discharged. During a second time, the first capacitor C₁ is disconnected from the diode 10 using the first switch S₁ and the second capacitor C₂ is connected via the second switch S₂ to the first capacitor C₁. The charge is thus shared between the capacitors C₁ and C₂. The second capacitor C₂ has a second capacitance (k−1)*C, so that the voltage drop across the capacitors is V_{BE}/k. The scaled voltage V_{BE}/k is the output of the switched capacitor voltage divider 40.

The process 1000 also comprises providing a resistor CTAT current I_{CTAT}, which is proportional to the scaled voltage V_{BE}/k and inversely proportional to a resistance value R_{CTAT} of a resistor 30 (step 1030). The resistor current I_{CTAT} is provided by a voltage-to-current converter 50 that is connected to the output of the switched capacitor voltage divider 40. The voltage-to-current converter comprises an operational amplifier 20 and a transistor M₃ through which a current I_{CTAT} flows. The transistor M₃ is connected to the resistor 30 and provides the current I_{CTAT} to the resistor 30. Since the voltage across the resistor 30 is equal to the scaled voltage V_{BE}/k, the current flowing through the resistor 30 is equal to V_{BE}/(k·R_{CTAT}). In one example, the resistor current I_{CTAT} is equal to the current V_{BE}/(k·R_{CTAT}) that flows through the resistor 30. In another example, the resistor current I_{CTAT} is proportional to the current that flows through the resistor 30. The current I_{CTAT}, which flows through the transistor M₃ of the voltage-to-current converter 50, is mirrored by the current mirror to provide the diode current I_{C}. The diode current I_{C} thus depends on the current I_{CTAT}. In one example, the diode current I_{C} is equal to the current I_{CTAT}. Since the current flowing through the resistor 30 is reduced, the power consumption can be decreased. In addition, it is possible to use a resistor 30 having a decreased resistance value so as to obtain a more compact assembly.

In one example, the artifacts that are caused by the switching operations of the switched capacitor voltage divider 40 are smoothed by a filter 60, in particular an analog passive filter, arranged between the switched capacitor voltage divider 40 and the voltage-to-current converter 50. In addition, the operational amplifier 20 of the voltage-to-current converter 50 may be a small-bandwidth operational amplifier that further reduces the artifacts of the scaled voltage V_{BE}/k.

In one example, the current I_{RCTAT} flowing through the resistor 30 is the sum of the current I_{CTAT} flowing through the transistor M and of at least a further current I_{OUTN}, I₄, I₅ that flows through an output transistor M_{OUTN}, M₄, M₅ of the voltage-to-current converter 50. The at least one output transistor M_{OUTN}, M₄, M₅ is connected to the main transistor M₃ of the voltage-to-current converter 50 in a mirror configuration. The output currents I_{OUTN}, I₄, I₅ are proportional to the resistor current I_{CTAT} and can be used for further bandgap operations. Further, since the addition of the output current increases the total current flowing through the resistor 30, it is possible to further decrease the resistance value R_{CTAT} of the resistance 30.

The present application describes the use of a switched capacitor voltage divider in a circuit for providing a CTAT current. This circuit is configured to be used in a bandgap voltage reference circuit and usually comprises a diode and a resistor. The current flowing through the resistor is proportional to the CTAT current. According to the application, the switched capacitor voltage divider is connected between the diode and the resistor. Since the switched capacitor voltage divider provides a scaled voltage to the resistor, it is possible to reduce both the CTAT current and the resistance value of the resistor. With this, the current consumption can be kept low and the chip area dedicated to the resistor can be decreased, leading to a more compact assembly. The switched capacitor voltage divider only has any passive elements and does not require a precise clock. Switching artifacts of the scaled voltage can be smoothed by using a passive analog filter and a voltage-to-current converter having a small-bandwidth operational amplifier. The resulting circuit has a very low power consumption and can be used for low-power bandgap applications.

Although various embodiments have been illustrated and described with respect to one or more specific implementations, alterations and/or modifications may be made to the illustrated examples without departing from the spirit and scope of the features and structures recited herein. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the present disclosure.

What is claimed is:

1. A circuit comprising:
a resistor;
a diode configured to receive a diode current so that a forward-voltage occurs across the diode;
a switched capacitor voltage divider that is connected to the diode and configured to receive the forward-voltage and to output a scaled voltage that is a fraction of the forward-voltage;
a voltage-to-current converter that is coupled between the switched capacitor voltage divider and the resistor and that is configured to provide a resistor current proportional to the scaled voltage and inversely proportional to a resistance of the resistor; and
a current source configured to provide the diode current dependent on the resistor current.

2. The circuit of claim 1, wherein the diode is base-emitter junction of a bipolar transistor.

3. The circuit of claim 1, wherein the current source comprises:
a first transistor coupled to the diode, and
a second transistor coupled to the resistor,
wherein the first transistor and the second transistor form a current mirror configured to mirror the resistor current to the diode current.

4. The circuit of claim 1, wherein the switched capacitor voltage divider comprises a controller, a first capacitor, a second capacitor configured to be coupled in parallel with the first capacitor, wherein the controller is configured to:
during a first time period: connect the first capacitor to the diode via a first switch so as to apply the forward-voltage to the first capacitor, disconnect the second capacitor from the first capacitor using a second switch, and connecting the second capacitor to ground using a third switch, and
during a second time period: disconnect the first capacitor from the diode using the first switch, and connect the second capacitor to the first capacitor via the second switch.

5. The circuit of claim 4, wherein the first capacitor comprises a first capacitance and the second capacitor comprises a second capacitance which is a factor k−1 larger than the first capacitance, wherein k is a division ratio of the switched capacitor voltage divider.

6. The circuit of claim 1, further comprising an analog filter connected between the switched capacitor voltage divider and the voltage-to-current converter, the analog filter configured to smooth artifacts produced by operations of the switched capacitor voltage divider to produce the scaled voltage.

7. The circuit of claim 1, wherein the voltage-to-current converter comprises an operational amplifier and a third transistor,
wherein the operational amplifier and the third transistor are coupled such that the third transistor provides, as the resistor current, a current that is proportional to an input voltage of the voltage-to-current converter.

8. The circuit of claim 7, further comprising at least one output transistor,
wherein the at least one output transistor is connected to third transistor of the voltage-to-current converter such that the third transistor and the at least one output transistor form a current mirror configured to provide an output current that is a replica of the resistor current.

9. A full bandgap reference circuit, comprising:
the circuit of claim 1, and
a further circuit that is configured to output a current that is proportional to an absolute temperature with respect to a reference resistor,
wherein the full bandgap reference circuit is configured to sum the resistor current and the current output by the further circuit.

10. A method, comprising:
supplying a diode current to a diode so that a forward voltage occurs across the diode;
generating, by a switched capacitor voltage divider, a scaled voltage from the forward voltage; and
providing a resistor current proportional to the scaled voltage and inversely proportional to a resistance of a resistor, wherein the diode current depends on the resistor current.

11. The method of claim 10, further comprising:
during a first time, connecting a first capacitor of the switched capacitor voltage divider to the diode via a first switch to apply the forward voltage to the first capacitor, disconnect a second capacitor of the switched capacitor voltage divider from the first capacitor using a second switch, and connect the second capacitor to ground through a third switch, and
during a second time, disconnect the first capacitor from the diode using the first switch and connect the second capacitor to the first capacitor via the second switch.

12. A circuit, comprising:
complementary to absolute temperature (CTAT) circuit comprising:
a switched-capacitor voltage divider,
a voltage-to-current converter coupled to an output of the switched-capacitor voltage divider, wherein a first output node of the voltage-to-current converter is configured to provide a CTAT current with respect to a reference resistance,
a current mirror having an input coupled to a second output node of the voltage-to-current converter, and
a diode junction coupled to an output of the current mirror and to an input of the switched-capacitor voltage divider.

13. The circuit of claim 12, wherein the CTAT circuit further comprises an analog filter coupled between the output of the switched-capacitor voltage divider and the input to the voltage-to-current converter.

14. The circuit of claim 12, wherein the voltage-to-current converter comprises:
a first transistor having an output node coupled to the input of the current mirror;
a resistor coupled to a reference node of the first transistor, wherein the resistor comprises the reference resistance; and
an amplifier having a first input coupled to the output of the switched-capacitor voltage divider, a second input coupled to the reference node of the transistor, and an output coupled to the reference node of the first transistor.

15. The circuit of claim 14, wherein the voltage-to-current converter further comprises a second transistor having a control node coupled to the output of the amplifier and an output node forming the first output node of the voltage-to-current converter.

16. The circuit of claim 12, further comprising:
a proportional to absolute temperature (PTAT) circuit; and
a current summing node coupled to a current output of the PTAT circuit and the first output node of the voltage-to-current converter.

17. The circuit of claim 16, further comprising an output resistor coupled to the current summing node.

18. The circuit of claim 17, further comprising an amplifier having an input coupled to the output resistor, wherein the amplifier is configured to output a bandgap reference voltage.

19. The circuit of claim 17, further comprising a limited current oscillator having an clock output coupled to a clock input of the switched-capacitor voltage divider.
